(19) United States
(12) Patent Application Publication
(10) Pub. No.: US 2007/0267047 A1
(43) Pub. Date: Nov. 22, 2007

(54) SUBSTRATE PROCESSING METHOD AND SUBSTRATE PROCESSING APPARATUS

(76) Inventors: Shimpei Hori, Kyoto (JP); Masakazu Sanada, Kyoto (JP); Tomohiro Goto, Kyoto (JP)

Correspondence Address: OSTROLENK FABER GERB & SOFFEN, 1180 AVENUE OF THE AMERICAS, NEW YORK, NY, 100368403, US

(21) Appl. No.: 11/748,654

(22) Filed: May 15, 2007

(30) Foreign Application Priority Data
May 17, 2006 (JP) 2006-137182

(51) Int. Cl. B08B 7/00; B08B 3/00; B08B 3/12

(52) U.S. Cl. 134/33; 134/137; 134/149; 134/172

(57) ABSTRACT

The invention provides a method capable of suppressing liquid splash at the circumferential edge of a substrate, and preventing liquid droplets due to liquid splash from adhering to the substrate again when moving a discharge nozzle for scanning while discharging a cleaning solution from the discharge nozzle to the surface of the substrate to make spin drying of the substrate. When a substrate W is held in a horizontal posture by a spin chuck 10 and rotated about a vertical axis with a rotation motor 14, while discharging the cleaning solution onto the surface of the substrate from an outlet of a de-ionized water discharge nozzle 20, the rotation speed of the substrate is decreased in a process that the outlet of the discharge nozzle is traveled from a position opposed to a center of the substrate to a position opposed to the circumferential edge of the substrate.

### BACKGROUND OF THE INVENTION

1. Field of the Invention

The present invention relates to a substrate processing method and a substrate processing apparatus in which substrates such as semiconductor wafers, liquid crystal display glass substrates, photo-mask glass substrates, and optical disk substrates are rotated about a vertical axis in a horizontal plane, and subjected to drying treatment while a cleaning solution such as de-ionized water (DI water) is being fed onto the surface of the substrates.

2. Description of the Related Art

In the conventional manufacturing process of semiconductor devices, a lithographic technology is employed and in which, a circuit pattern is formed on the resist film on the substrate by performing each of the steps of applying a photo-resist, for example, on a silicone substrate, printing a circuit pattern on a resist film on the substrate using an exposure device, and developing the resist film having been exposed with a developer. In the processing step, a developer is fed onto a resist film having been exposed that is formed on the surface of a substrate with, for example, a slit nozzle, and thereafter, a cleaning solution (rinse) such as DI water is discharged to the center of the substrate from an outlet of a straight nozzle while the substrate is being rotated about a vertical axis in a horizontal plane. The cleaning solution having been fed to the center of the substrate is spread toward the circumferential edge of the substrate by a centrifugal force to extend over the entire substrate, and acts to wash out the developer from the resist film on the substrate surface. When ending this cleaning treatment (rinse treatment), feeding the cleaning solution from the nozzle onto the substrate is stopped. Thereafter, the number of revolutions of the substrate is further increased, and thus the cleaning solution on the resist film on the substrate surface is shaken off by the centrifugal force, thereby making drying (spin drying) of the substrate.

Incidentally, in case of making spin drying of a substrate as described above, it sometimes occurs that liquid droplets of the cleaning solution remain as spots on the substrate. The reason thereof is that the hydrophilic portions and the hydrophobic portions coexist on the surface of a resist film on the substrate having been processed, whereby unevenness in retention of the cleaning solution occurs on the substrate. Liquid droplets of the cleaning solution remained as spots on a resist pattern formed on the surface of the substrate like this are found to be the cause of inducing any processing failure.

To overcome the above-mentioned problems, a method (called scan rinse method) has been proposed, and in which at the time of spin drying of a substrate, while a cleaning solution is being discharged from the outlet of a cleaning solution discharge nozzle, the outlet of this discharge nozzle is moved for scanning from the center toward the periphery of the substrate. By this method, since drying goes on in the state that a liquid film of the cleaning solution is formed and held from the center to circumferential edge of the substrate, despite a resist film surface on which hydrophilic portions and hydrophobic portions coexist, liquid droplets of the cleaning solution are less likely to remain on the substrate.

Furthermore, the Japanese Patent No. 3694641 proposes a method in which when a discharge nozzle is moved for scanning while a cleaning solution is being discharged from an outlet of the discharge nozzle of the cleaning solution, with gas blown out from an air blowing nozzle, the air blowing nozzle is traveled from the center toward the periphery of the substrate integrally or in synchronization with the discharge nozzle of the cleaning solution.

It is certain that, in the above-mentioned scan rinse method, processing failures can be largely reduced as compared with the conventionally known spin drying, but the occurrence of processing failures cannot be eliminated. That is, in the scan rinse method, although an outlet of the cleaning solution discharge nozzle is moved for scanning from the center toward the periphery of a substrate while the cleaning solution is being discharged from the outlet of the cleaning solution discharge nozzle, due to that the substrate is affected by a turbulent flow at the circumferential edge portion or rotated at a larger circumferential speed at the circumferential edge portion, splash of the cleaning solution discharged onto the substrate from the discharge nozzle is likely to occur. Therefore, a problem exists in that liquid droplets due to the liquid splash are splashed and adhered to the surface on the center side from the discharge nozzle traveling from the center toward the periphery of the substrate, and thus processing failures occur with these liquid droplets.

### SUMMARY OF THE INVENTION

The present invention has been made to solve the above-discussed problems, and has an object of providing a substrate processing method in which liquid splash at the circumferential edge of a substrate is suppressed, and liquid droplets due to liquid splash is prevented from being adhered to the substrate again, thereby eliminating the occurrence of processing failure and the like when the discharge nozzle is moved for scanning from the center to the circumferential edge of the substrate while a cleaning solution is being discharged from an outlet of the discharge nozzle onto the surface of the substrate to make spin drying of the substrate. The invention also provides a substrate processing apparatus with which the above-mentioned method can be preferably carried out.

The invention according to claim 1 is a substrate processing method in which a substrate is held in a horizontal posture to rotate about a vertical axis; and while a cleaning solution is being discharged onto a surface of the substrate from an outlet of a discharge nozzle, the mentioned outlet of the discharge nozzle is moved for scanning from a position opposed to a center of the substrate to a position opposite to a circumferential edge of the substrate. In this substrate processing method, a rotation speed of the substrate is decreased in a process that the mentioned outlet of the discharge nozzle is traveled from the position opposed to the center of the substrate to the position opposed to the circumferential edge of the substrate.

The invention as defined in claim 2 is the substrate processing method according to claim 1, and in which the rotation speed of the substrate is changed at least once on the way when the mentioned outlet of the discharge nozzle is traveled from the position opposed to the center of the substrate to the position opposed to the circumferential edge of the substrate.

The invention as defined in claim 3 is the substrate processing method according to claim 1, and in which the rotation speed of the substrate is decreased by degrees as the mentioned outlet of the discharge nozzle is traveled from the position opposed to the center of the substrate to the position opposed to the circumferential edge of the substrate.

The invention according to claim 4 is a substrate processing apparatus comprising: substrate holding means for holding a substrate in a horizontal posture; substrate rotating means for rotating the substrate held by this substrate holding means about a vertical axis; a discharge nozzle for discharging a cleaning solution from an outlet onto a surface of the substrate held by the mentioned substrate holding means and rotated by the mentioned substrate rotating means; cleaning solution feed means for feeding the cleaning solution to this discharge nozzle; and nozzle moving means for moving the mentioned outlet of the discharge nozzle for scanning from a position opposed to a center of the substrate to a position opposed to a circumferential edge of the substrate while the cleaning solution is being discharged onto a surface of the substrate from this outlet. In this substrate processing apparatus, there is further provided control means for controlling the mentioned substrate rotating means so that a rotation speed of the substrate is decreased in a process that the mentioned outlet of the discharge nozzle is traveled from the position opposed to the center of the substrate to the position opposed to the circumferential edge of the substrate.

The invention as defined in claim 5 is a substrate processing method in which a substrate is held in a horizontal posture to rotate about a vertical axis; and while a cleaning solution is being discharged onto a surface of the substrate from an outlet of a discharge nozzle, the mentioned outlet of the discharge nozzle is moved for scanning from a position opposed to a center of the substrate to a position opposed to a circumferential edge of the substrate. In this substrate processing method, a discharge flow of the cleaning solution to be discharged onto the surface of the substrate from the mentioned outlet of the discharge nozzle is decreased in a process that the mentioned outlet of the discharge nozzle is traveled from the position opposed to the center of the substrate to the position opposed to the circumferential edge of the substrate.

The invention as defined in claim 6 is the substrate processing method according to claim 5, and in which the discharge flow of the cleaning solution is changed at least once on the way when the mentioned outlet of the discharge nozzle is traveled from the position opposed to the center of the substrate to the position opposed to the circumferential edge of the substrate.

The invention according to claim 7 is the substrate processing method according to claim 5, and in which the discharge flow of the cleaning solution is decreased by degrees as the mentioned outlet of the discharge nozzle is traveled from the position opposed to the center of the substrate to the position opposed to the circumferential edge of the substrate.

The invention as defined in claim 8 is a substrate processing apparatus comprising: substrate holding means for holding a substrate in a horizontal posture; substrate rotating means for rotating the substrate held by this substrate holding means about a vertical axis; a discharge nozzle for discharging a cleaning solution from an outlet to a surface of the substrate held by the mentioned substrate holding means and rotated by the mentioned substrate rotating means; cleaning solution feed means for feeding the cleaning solution to this nozzle; and nozzle moving means for moving the mentioned outlet of the discharge nozzle for scanning from a position opposed to a center of the substrate to a position opposed to a circumferential edge of the substrate while the cleaning solution is being discharged onto a surface of the substrate from this outlet. In this substrate processing apparatus, there is further provided control means for controlling the mentioned cleaning solution feed means so that a discharge flow of the cleaning solution to be discharged onto the surface of the substrate from the mentioned outlet of the discharge nozzle is decreased in a process that the mentioned outlet of the discharge nozzle is traveled from the position opposed to the center of the substrate to the position opposed to the circumferential edge of the substrate.

The invention as defined in claim 9 is a substrate processing method in which a substrate is held in a horizontal posture to rotate about a vertical axis; and while a cleaning solution is being discharged onto a surface of the substrate from an outlet of a discharge nozzle, the mentioned outlet of the discharge nozzle is moved for scanning from a position opposed to a center of the substrate to a position opposed to a circumferential edge of the substrate. In this substrate processing method, a discharge pressure of a cleaning solution to be discharged onto the surface of the substrate from the mentioned outlet of the discharge nozzle is decreased in the process that the mentioned outlet of the discharge nozzle is traveled from the position opposed to the center of the substrate to the position opposed to the circumferential edge of the substrate.

The invention as defined in claim 10 is the substrate processing method according to claim 9, and in which the discharge pressure of the cleaning solution is changed at least once on the way when the mentioned outlet of the discharge nozzle is traveled from the position opposed to the center of the substrate to the position opposed to the circumferential edge of the substrate.

The invention as defined in claim 11 is the substrate processing method according to claim 9, and in which the discharge pressure of the cleaning solution is decreased by degrees as the mentioned outlet of the discharge nozzle is traveled from the position opposed to the center of the substrate to the position opposed to the circumferential edge of the substrate.

The invention as defined in claim 12 is a substrate processing apparatus comprising: substrate holding means for holding a substrate in a horizontal posture; substrate rotating means for rotating the substrate held by this substrate holding means about a vertical axis; a discharge nozzle for discharging a cleaning solution from an outlet to a surface of the substrate held by mentioned substrate holding means and rotated by mentioned substrate rotating means; cleaning solution feed means for feeding the cleaning solution to this discharge nozzle; and nozzle moving means for moving the mentioned outlet of the discharge nozzle for scanning from a position opposed to a center of the substrate to a position opposed to a circumferential edge of the substrate while the cleaning solution is being discharged onto the surface of the substrate from this outlet. In substrate processing apparatus there is further provided control means for controlling the mentioned cleaning solution feed means so that a discharge pressure of the cleaning solution to be discharged onto the surface of the substrate from the mentioned outlet of the discharge nozzle is decreased in a process that the mentioned outlet of the discharge nozzle is traveled from the position opposed to the center of the substrate to the position opposed to the circumferential edge of the substrate.

According to the substrate processing method of the invention as defined in claim 1, when the outlet of a discharge nozzle is moved for scanning to come in the vicinity of the circumferential edge of a substrate, the rotation speed of the substrate is decreased as compared with that when the outlet of the discharge nozzle is positioned in the vicinity of the center of the substrate. As a result, the substrate at the circumferential edge portion is less affected by a turbulent flow in drying, and further the substrate is not rotated at a larger circumferential speed at the circumferential edge portion as compared with that at the central portion of the substrate. Consequently, liquid splash of the cleaning solution at the circumferential edge portion of the substrate is suppressed, and thus liquid droplets due to liquid splash is prevented from being splashed and adhered to the substrate surface on the center side from the discharge nozzle, so that the occurrence of processing failures is eliminated.

In the substrate processing method of the invention as defined in claim 2, the rotation speed of a substrate is switched to be lower on the way when the outlet of the discharge nozzle is traveled from the position opposed to the center of the substrate to the position opposed to the circumferential edge of the substrate. As a result, liquid splash of the cleaning solution at the circumferential edge portion of the substrate is suppressed.

In the substrate processing method of the invention as defined in claim 3, the rotation speed of the substrate is decreased by degrees as the outlet of the discharge nozzle is traveled from the position opposed to the center of the substrate to the position opposed to the circumferential edge of the substrate. As a result, liquid splash of the cleaning solution at the circumferential edge portion of the substrate is suppressed.

In the substrate processing apparatus of the invention as defined in claim 4, substrate rotating means is controlled by the control means, and thus the rotation speed of the substrate is decreased in the process that the outlet of the discharge nozzle is traveled from the position opposed to the center of the substrate to the position opposed to the circumferential edge of the substrate. As a result, when using the substrate processing apparatus of the invention as defined in claim 4, the substrate processing method of the invention according to claim 1 is preferably carried out, thus enabling to provide the above-mentioned advantages.

According to the substrate processing method of the invention as defined in claim 5, when the outlet of a discharge nozzle is moved for scanning to come in the vicinity of the circumferential edge of a substrate, the discharge flow of the cleaning solution to be discharged onto the surface of the substrate from the outlet of the discharge nozzle is decreased as compared with that when the outlet of the discharge nozzle is positioned in the vicinity of the center of the substrate. As a result, liquid splash of the cleaning solution at the circumferential edge portion of the substrate is suppressed, and thus liquid droplets due to liquid splash is prevented from being splashed and adhered to the substrate surface on the center side from the discharge nozzle, so that the occurrence of processing failures can be eliminated.

In the substrate processing method of the invention as defined in claim 6, the discharge flow of the cleaning solution is changed to be smaller on the way when the outlet of the discharge nozzle is traveled from the position opposed to the center of the substrate to the position opposed to the circumferential edge of the substrate. As a result liquid splash of the cleaning solution is suppressed at the circumferential edge portion of a substrate.

In the substrate processing method of the invention as defined in claim 7, the discharge flow of the cleaning solution is decreased by degrees as the outlet of the discharge nozzle is traveled from the position opposed to the center of the substrate to the position opposed to the circumferential edge of the substrate. As a result, liquid splash of the cleaning solution is suppressed at the circumferential edge portion of a substrate

In a substrate processing apparatus of the invention as defined in claim 8, the cleaning solution feed means is controlled by control means, and thus the discharge flow of the cleaning solution to be discharged onto the surface of the substrate from the outlet of the discharge nozzle is decreased in the process that the outlet of the discharge nozzle is traveled from the position opposed to the center of the substrate to the position opposed to the circumferential edge of the substrate. As a result, when using the substrate processing apparatus as defined in claim 8, the substrate processing method of the invention according to claim 5 is preferably carried out, thus enabling to provide the above-mentioned advantages.

According to a substrate processing method of the invention as defined in claim 9, when the outlet of a discharge nozzle is moved for scanning to come in the vicinity of the circumferential edge of a substrate, the discharge pressure of the cleaning solution to be discharged onto the surface of the substrate from the outlet of the discharge nozzle is decreased as compared with that when the outlet of the discharge nozzle is positioned in the vicinity of the center of the substrate. As a result, liquid splash of the cleaning solution at the circumferential edge portion of the substrate is suppressed, and thus liquid droplets made due to liquid splash is prevented from being splashed and adhered to the substrate surface on the center side from the discharge nozzle, so that the occurrence of processing failures is eliminated.

In the substrate processing method of the invention as defined in claim 10, the discharge pressure of the cleaning solution is changed to be lower on the way when the outlet of the discharge nozzle is traveled from the position opposed to the center of the substrate to the position opposed to the circumferential edge of the substrate. As a result, liquid splash of the cleaning solution at the circumferential edge portion of a substrate is suppressed.

In the substrate processing method of the invention as defined in claim 11, the discharge pressure of the cleaning solution is decreased by degrees as the outlet of the discharge nozzle is traveled from the position opposed to the center of the substrate to the position opposed to the circumferential edge of the substrate. As a result, liquid splash of the cleaning solution at the circumferential edge portion of a substrate is suppressed.

In the substrate processing apparatus of the invention as defined in claim 12, the cleaning solution feed means is controlled by control means, and thus the discharge pressure of the cleaning solution to be discharged onto the surface of the substrate from the outlet of the discharge nozzle is decreased in the process that the outlet of the discharge nozzle is traveled from the position opposed to the center of the substrate to the position opposed to the circumferential edge of the substrate. As a result, when using the substrate processing apparatus of the invention as defined in claim 12, the substrate processing method of the invention according to claim 9 is preferably carried out, thus enabling to provide the above-mentioned advantages.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a schematic sectional view illustrating one example of construction of a substrate processing apparatus for use in carrying out a substrate processing method according to the present invention.

FIG. 2 is a schematic plan view of the substrate processing apparatus illustrated in FIG. 1.

FIG. 3 shows one example for carrying out the substrate processing method according to the invention, and is a chart of indicating the rotation speed of a substrate in each position of a discharge nozzle with respect to the surface of the substrate.

FIGS. 4 are views illustrating results of comparison between the state of liquid splash when making scan rinse by the substrate processing method according to the invention, and the state of liquid splash when making scan rinse by the conventional method.

FIG. 5 is a schematic sectional view illustrating another construction example of a substrate processing apparatus for use in carrying out a substrate processing method according to this invention.

FIG. 6 is a schematic sectional view illustrating a further construction example of a substrate processing apparatus for use in carrying out a substrate processing method according to the invention.

### DESCRIPTION OF THE PREFERRED EMBODIMENT

Hereinafter, the best mode for carrying out the present invention is described referring to the drawings.

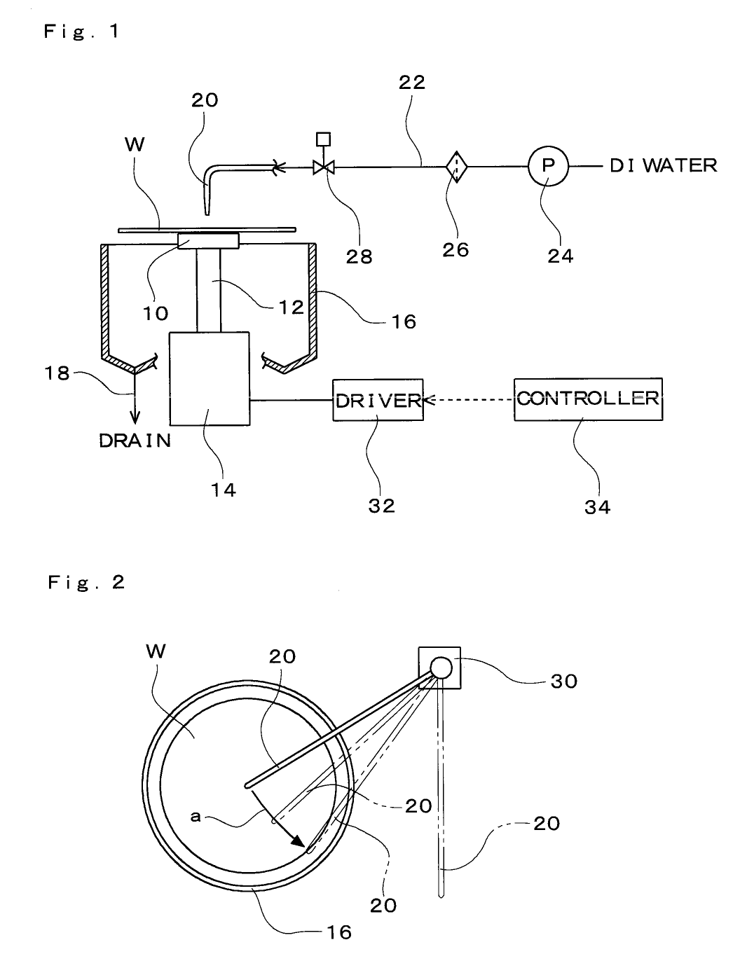

FIGS. 1 and 2 illustrates one example of construction of a substrate processing apparatus for use in carrying out a substrate processing method according to the invention, and in which FIG. 1 is a schematic sectional view of a substrate processing apparatus and FIG. 2 is a schematic plan view thereof.

This substrate processing apparatus makes a cleaning treatment (rinse treatment) after a substrate, on which surface a resist film having been exposed is formed, has been processed. The substrate processing apparatus is provided with a spin chuck 10 holding a substrate W in a horizontal posture, a rotary shaft 12 to which upper end portion the spin chuck 10 is fixed and which is supported in a vertical direction, and a rotation motor 14 of which rotary shaft is connected to the rotary shaft 12 and which causes the spin chuck 10 and the rotary shaft 12 to rotate about the vertical shaft. A cup 16 is disposed around the spin chuck 10 so as to surround a substrate W on the spin chuck 10. The cup 16 is supported in a reciprocally movable manner in a vertical direction, and has a drainage tube 18 connected in communication to the bottom of the cup 16. Further, although illustration thereof is omitted in FIGS. 1 and 2, there is provided a mechanism of feeding a developer onto a substrate W, for example, a developer feeding mechanism including a developer discharge nozzle in lower end of which a slit-like outlet is formed, and while a developer is being discharged from this slit-like outlet, causing this developer discharge nozzle to linearly move in the horizontal direction orthogonal to this slit-like outlet to feed the developer onto the substrate W to be evenly spread thereon; or a developer feeding mechanism including a developer discharge nozzle formed of a straight nozzle, supporting this developer discharge nozzle so as to reciprocate between the discharge position where the outlet at the leading end is located right over the center of the substrate W and the stand-by position, and discharging a developer from the leading end outlet of the developer discharge nozzle over the center of the substrate W.

Furthermore, in the side vicinity of the cup 16, there is provided a DI water discharge nozzle 20 for discharging a cleaning solution (rinse), for example, DI water from an outlet at the leading edge. The DI water discharge nozzle 20 is connected to channel to a DI water supply source through a DI water feed tube 22. A pump 24, a filter 26, and an opening/closing control valve 28 are interposed in the DI water feed tube 28. The DI water discharge nozzle 20 is held by a nozzle-holding portion 30 so as to be pivotable in the horizontal plane, and is pivoted in the horizontal plane by a pivotal driving mechanism not illustrated. In addition, the DI water discharge nozzle 20 is arranged such that while DI water is being discharged onto the surface of the substrate W from the outlet at the leading end, as indicated by the arrow a in FIG. 2, the outlet is scanned from the position opposed to the center of the substrate W to the position opposed to the circumferential edge of the substrate W, and further such that the outlet is reciprocated between the stand-by position of being spaced apart outward from the cup 16 as indicated by the two-dot-chain lines, and the position of the outlet being located right over the center of the substrate W.

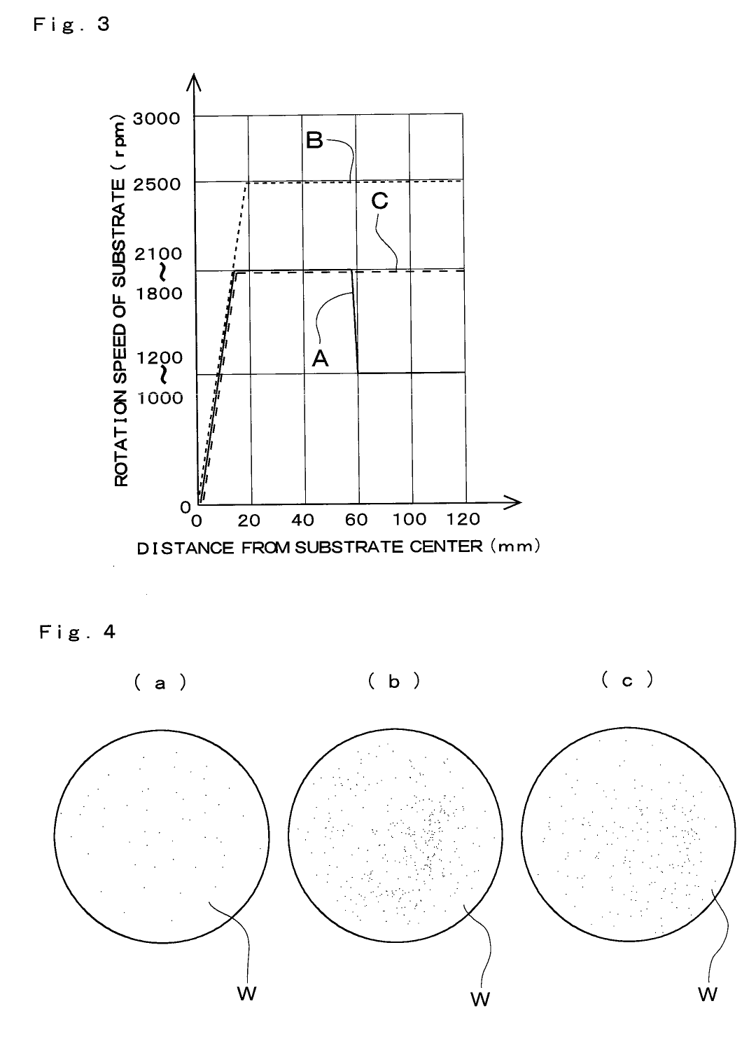

Further, this substrate processing apparatus is provided with a controller 34 for controlling a driver 32 of the rotation motor 14 to adjust the number of revolutions of the rotation motor 14, being thus the rotation speed of the substrate W. With this controller 34, the number of revolutions of the rotation motor 14 is controlled so that the rotation speed of the substrate W is decreased in the process that the outlet of the DI water discharge nozzle 20 is scanned from the position opposed to the center of the substrate W to the position opposed to the circumferential edge of the substrate W. More specifically, as indicated by the solid line A, at a time point at which the outlet of the DI water discharge nozzle 20 is moved by a predetermined distance from the center of the substrate W (at a time point of reaching a radial position of 60 mm spaced apart from the center of the substrate W in the illustrated example), the substrate W is controlled so as to decrease in rotation speed of the substrate (to reduce in speed from the number of revolutions being in the range of 1800 rpm to 2100 rpm to the number of revolutions being in the range of 1000 rpm to 1200 rpm). It is preferable that the timing of switching the rotation speed of the substrate W is controlled with a microcomputer on the basis of an operating program. Alternatively, it is preferable that the position of the DI water discharge nozzle 20 is detected with an encoder, and the rotation speed of the substrate W is switched with signals detected from this encoder; that the rotation speed of the substrate W is switched at a time point when a predetermined time period has passed since the time point of scanning of the DI water discharge nozzle 20 being started; or that the rotation speed of the substrate W is switched at a time point when the number of rotations of the substrate W has reached a predetermined number of rotations. Furthermore, the number of times of the rotation speed of the substrate W being changed is not limited to once as shown in FIG. 3, but the rotation speed of the substrate W may be decreased stepwise. Alternatively, as the outlet of the DI water discharge nozzle 20 is traveled from the position opposed to the center of the substrate W to the position opposed to the circumferential edge of the substrate W, the rotation speed of the substrate W may be controlled so as to decrease by degrees, for example, decrease linearly.

With the use of a substrate processing apparatus illustrated in FIGS. 1 and 2, a developer is fed onto a resist film having been exposed and formed on the surface of a substrate W, to make processing of the resist film; thereafter DI water is fed onto the substrate W while the substrate W being rotated at a comparatively low speed to make the cleaning treatment; the developer is washed out to be removed from the resist film on the surface of the substrate W; and subsequently the substrate W is brought in rotation at a comparatively high speed to make the spin drying (scan rinse). In making the scan rinse, the substrate W is rotated at a comparatively high speed, for example, at a rotation speed within the range of 1800 rpm to 2100 rpm, as well as the DI water discharge nozzle 20 is scanned while DI water is being discharged onto the substrate W from the outlet of the DI water discharge nozzle 20. On that occasion, in the process that the outlet of the DI water discharge nozzle 20 is traveled from the position opposed to the center of the substrate W to the position opposed to the circumferential edge of the substrate W, at a time point when the outlet of the DI water discharge nozzle 20 has reached a predetermined position, for example, the radial position of 60 mm spaced apart from the center of the substrate W, the rotation speed of the substrate W is switched to reduce to the rotation speed in the range of, for example, 1000 rpm to 1200 rpm. When the outlet of the DI water discharge nozzle 20 has reached the position opposed to the circumferential edge of the substrate W, feeding of DI water onto the substrate W from the DI water discharge nozzle 20 is stopped, and the DI water discharge nozzle 20 is made to move to the stand-by position. Then, when the drying of the substrate W has completed, the rotation of the substrate W is stopped.

Illustrated in FIG. 4 are results of comparison between the state of liquid splash when making scan rinse in the above-mentioned method (indicated by the solid line in FIG. 3), and the state of liquid splash when making scan rinse without change in the rotation speed of the substrate W as in the conventional method. The surface state of the substrate W when making scan rinse with the substrate W kept in rotation speed of 2500 rpm as indicated by the broken line B in FIG. 3 is illustrated in FIG. 4(b), and the surface state of the substrate W when making scan rinse with the substrate W kept in rotation speed of 1800 rpm to 2100 rpm as indicated by the broken line C in FIG. 3 is illustrated in FIG. 4(c). As illustrated, the state of liquid splash is improved by decreasing the rotation speed of the substrate. When making scan rinse in the method according to this invention, as illustrated in FIG. 4(a), as compared with the case of making scan rinse with the substrate kept in rotation speed of 1800 rpm to 2100 rpm, the liquid splash of DI water at the circumferential edge portion of the substrate W is suppressed further, and thus liquid droplets due to liquid splash are found to be prevented from being splashed to the surface on the center side from the substrate W to adhere.

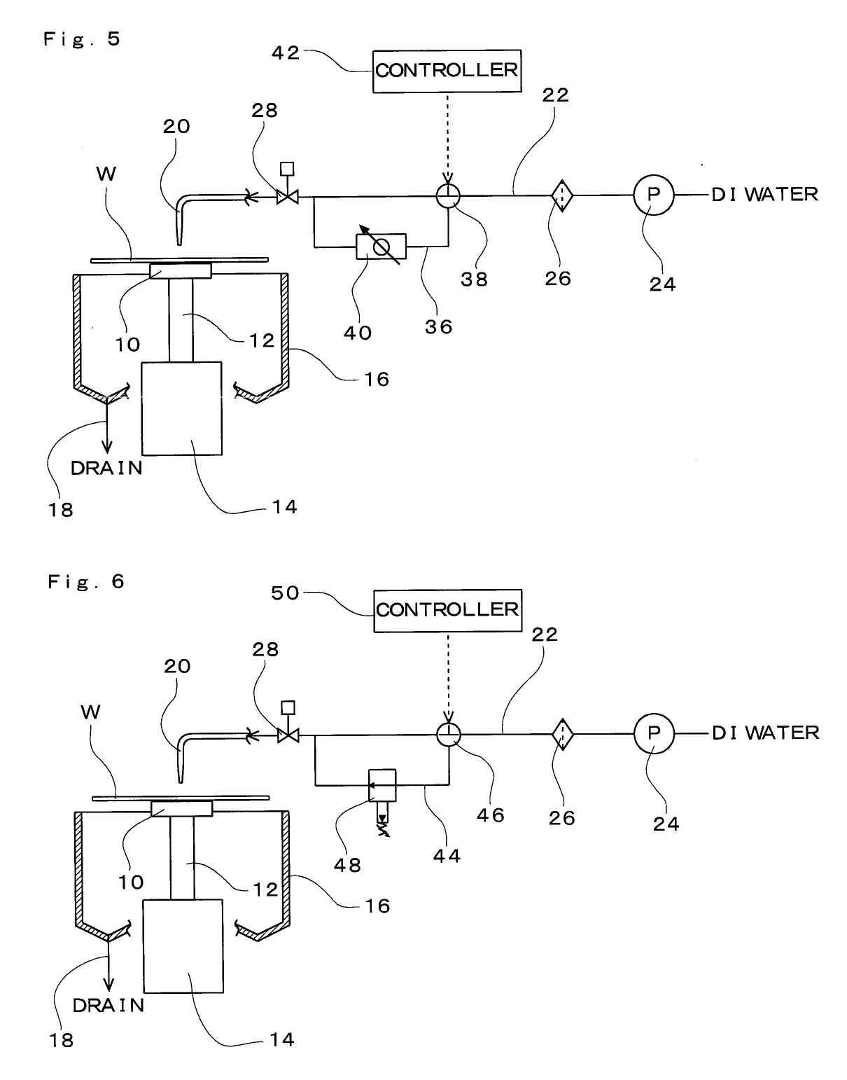

Now, FIG. 5 is a schematic sectional view illustrating another construction example of a substrate processing apparatus for use in carrying out the substrate processing method according to the invention.

This substrate processing apparatus is provided with a bypass tube 36 branched off on the way from the DI water feed tube 22. This bypass tube 36 is constructed in channel so as to meet the DI water feed tube 22 again. There is provided an electromagnetic three-way valve 38 at the branch position between the DI water feed tube 22 and the bypass tube 36. There is interposed in the bypass tube 36 a flow regulating valve 40 for decreasing the flow of DI water to be fed to the DI water discharge nozzle 20. Furthermore, this substrate processing apparatus is provided with a controller 42 acting to control switching operation of the electromagnetic three-way valve 38.

To carry out scan rinse with the use of the substrate processing apparatus illustrated in FIG. 5, a substrate W is rotated at a constant speed of comparatively high speed, for example, at a rotation speed of 1800 rpm to 2100 rpm; DI water is fed to the DI water discharge nozzle 20 through the DI water feed tube 22; and the DI water discharge nozzle 20 is scanned while DI water is being discharged onto the substrate W from the outlet of the DI water discharge nozzle 20. On that occasion, in the process that the outlet of the DI water discharge nozzle 20 is traveled from the position opposed to the center of the substrate W to the position opposed to the circumferential edge of the substrate W, at a time point when the outlet of the DI water discharge nozzle 20 has reached a predetermined position, for example, the radial position of 60 mm spaced apart from the center of the substrate W, the electromagnetic three-way valve 38 is switched in response to a control signal from the controller 42, and thus the DI water is arranged to feed the DI water discharge nozzle 20 through the bypass tube 36 via the flow regulating valve 40. Accordingly, in the vicinity of the circumferential edge of the substrate W, the discharge flow of DI water to be discharged onto the surface of the substrate W from the outlet of the discharge nozzle 20 is decreased as compared with that in the vicinity of the center of the substrate W. As a result, the liquid splash of DI water at the circumferential edge portion of the substrate W is suppressed, and thus liquid droplets due to liquid splash will be prevented from being splashed to the surface on the center side from the substrate W to adhere.

Furthermore, in the apparatus construction illustrated in FIG. 5, the discharge flow of DI water from the discharge nozzle 20 is decreased only once. However, it is preferable to be in such an apparatus construction that the discharge flow of DI water from the discharge nozzle 20 can be decreased stepwise in the process of the outlet of the DI water discharge nozzle 20 traveling from the position opposed to the center of the substrate W to the position opposed to the circumferential edge of the substrate W; or it is preferable to be in such an apparatus construction that the discharge flow of DI water from the discharge nozzle 20 is decreased by degrees as the outlet of the DI water discharge nozzle 20 is traveled from the position opposed to the center of the substrate W to the position opposed to the circumferential edge of the substrate W.

In addition, FIG. 6 is a schematic sectional view illustrating a further construction example of the substrate processing apparatus for use in carrying out the substrate processing method according to this invention.

This substrate processing apparatus, as is the apparatus illustrated in FIG. 5, is provided with a bypass tube 44 branched off on the way from the DI water feed tube 22 to meet the DI water feed tube 22 again. There is provided an electromagnetic three-way valve 46 at the branch position between the DI water feed tube 22 and the bypass tube 44. Further, there is interposed in the bypass tube 44 a pressure-reducing valve 48 for reducing the feed pressure of DI water to the DI water discharge nozzle 20. Furthermore, this apparatus is provided with a controller 50 acting to control switching operation of the electromagnetic three-way valve 46.

To carry out scan rinse with the use of the substrate processing apparatus illustrated in FIG. 6, a substrate W is rotated at a constant speed of comparatively high speed, for example, at a rotation speed of 1800 rpm to 2100 rpm; DI water is fed to the DI water discharge nozzle 20 through the DI water feed tube 22; and the DI water discharge nozzle 20 is scanned while the DI water is being discharged onto the substrate W from the outlet of the DI water discharge nozzle 20. On that occasion, in the process that the outlet of the DI water discharge nozzle 20 is traveled from the position opposed to the center of the substrate W to the position opposed to the circumferential edge of the substrate W, at a time point when the outlet of the DI water discharge nozzle 20 has reached a predetermined position, for example, the radial position of 60 mm spaced apart from the center of the substrate W, the electromagnetic three-way valve 46 is switched in response to a control signal from the controller 50, and thus the DI water is arranged to feed the DI water discharge nozzle 20 through the bypass tube 44 via the pressure-reducing valve 40. Accordingly, in the vicinity of the circumferential edge of the substrate W, the discharge pressure of DI water to be discharged onto the surface of the substrate W from the outlet of the discharge nozzle 20 is decreased as compared with that in the vicinity of the center of the substrate W. As a result, as is the apparatus illustrated in FIG. 5, the liquid splash of DI water at the circumferential edge portion of the substrate W is suppressed, and thus liquid droplets due to liquid splash will be prevented from being splashed to the surface on the center side from the substrate W to adhere.

Furthermore, in the apparatus construction illustrated in FIG. 6, the discharge pressure of DI water from the discharge nozzle 20 is decreased only once. However, it is preferable to be in such an apparatus construction that the discharge pressure of DI water from the discharge nozzle 20 can be decreased stepwise in the process of the outlet of the DI water discharge nozzle 20 traveling from the position opposed to the center of the substrate W to the position opposed to the circumferential edge of the substrate W; or it is preferable to be in such an apparatus construction that the discharge pressure of DI water from the discharge nozzle 20 is decreased by degrees as the outlet of the DI water discharge nozzle 20 is traveled from the position opposed to the center of the substrate W to the position opposed to the circumferential edge of the substrate W.

While the presently preferred embodiments of the present invention have been shown and described, it is to be understood that these disclosures are for the purpose of illustration and that various changes and modifications may be made without departing from the scope of the invention as set forth in the appended claims.

What is claimed is:

1. A substrate processing method in which a substrate is held in a horizontal posture to rotate about a vertical axis; and while a cleaning solution is being discharged onto a surface of the substrate from an outlet of a discharge nozzle, said outlet of the discharge nozzle is moved for scanning from a position opposed to a center of the substrate to a position opposed to a circumferential edge of the substrate;
wherein a rotation speed of the substrate is decreased in a process that said outlet of the discharge nozzle is traveled from the position opposed to the center of the substrate to the position opposed to the circumferential edge of the substrate.

2. The substrate processing method according to claim 1, wherein the rotation speed of the substrate is changed at least once on the way when said outlet of the discharge nozzle is traveled from the position opposed to the center of the substrate to the position opposed to the circumferential edge of the substrate.

3. The substrate processing method according to claim 1, wherein the rotation speed of the substrate is decreased by degrees as said outlet of the discharge nozzle is traveled from the position opposed to the center of the substrate to the position opposed to the circumferential edge of the substrate.

4. A substrate processing apparatus comprising:
substrate holding means for holding a substrate in a horizontal posture;
substrate rotating means for rotating the substrate held by said substrate holding means about a vertical axis;
a discharge nozzle for discharging a cleaning solution from an outlet onto a surface of the substrate held by said substrate holding means and rotated by said substrate rotating means;
cleaning solution feed means for feeding the cleaning solution to said discharge nozzle; and
nozzle moving means for moving said outlet of the discharge nozzle for scanning from a position opposed to a center of the substrate to a position opposed to a circumferential edge of the substrate while the cleaning solution is being discharged onto a surface of the substrate from said outlet;
wherein there is further provided control means for controlling said substrate rotating means so that a rotation speed of the substrate is decreased in a process that said outlet of the discharge nozzle is traveled from the position opposed to the center of the substrate to the position opposed to the circumferential edge of the substrate.

5. A substrate processing method in which a substrate is held in a horizontal posture to rotate about a vertical axis; and while a cleaning solution is being discharged onto a surface of the substrate from an outlet of a discharge nozzle, said outlet of the discharge nozzle is moved for scanning from a position opposed to a center of the substrate to a position opposed to a circumferential edge of the substrate;
wherein a discharge flow of the cleaning solution to be discharged onto the surface of the substrate from said outlet of the discharge nozzle is decreased in a process that said outlet of the discharge nozzle is traveled from the position opposed to the center of the substrate to the position opposed to the circumferential edge of the substrate.

6. The substrate processing method according to claim 5, wherein the discharge flow of the cleaning solution is changed at least once on the way when said outlet of the discharge nozzle is traveled from the position opposed to the center of the substrate to the position opposed to the circumferential edge of the substrate.

7. The substrate processing method according to claim 5, wherein the discharge flow of the cleaning solution is decreased by degrees as said outlet of the discharge nozzle is traveled from the position opposed to the center of the substrate to the position opposed to the circumferential edge of the substrate.

8. A substrate processing apparatus comprising:
substrate holding means for holding a substrate in a horizontal posture;
substrate rotating means for rotating the substrate held by said substrate holding means about a vertical axis;
a discharge nozzle for discharging a cleaning solution from an outlet to a surface of the substrate held by said substrate holding means and rotated by said substrate rotating means;
cleaning solution feed means for feeding the cleaning solution to said nozzle; and
nozzle moving means for moving said outlet of the discharge nozzle for scanning from a position opposed to a center of the substrate to a position opposed to a circumferential edge of the substrate while the cleaning solution is being discharged onto a surface of the substrate from said outlet;
wherein there is further provided control means for controlling said cleaning solution feed means so that a discharge flow of the cleaning solution to be discharged onto the surface of the substrate from said outlet of the discharge nozzle is decreased in a process that said outlet of the discharge nozzle is traveled from the position opposed to the center of the substrate to the position opposed to the circumferential edge of the substrate.

9. A substrate processing method in which a substrate is held in a horizontal posture to rotate about a vertical axis; and while a cleaning solution is being discharged onto a surface of the substrate from an outlet of a discharge nozzle, said outlet of the discharge nozzle is moved for scanning from a position opposed to a center of the substrate to a position opposed to a circumferential edge of the substrate;
wherein a discharge pressure of the cleaning solution to be discharged onto the surface of the substrate from said outlet of the discharge nozzle is decreased in a process that said outlet of the discharge nozzle is traveled from the position opposed to the center of the substrate to the position opposed to the circumferential edge of the substrate.

10. The substrate processing method according to claim 9, wherein the discharge pressure of the cleaning solution is changed at least once on the way when said outlet of the discharge nozzle is traveled from the position opposed to the center of the substrate to the position opposed to the circumferential edge of the substrate.

11. The substrate processing method according to claim 9, wherein the discharge pressure of the cleaning solution is decreased by degrees as said outlet of the discharge nozzle is traveled from the position opposed to the center of the substrate to the position opposed to the circumferential edge of the substrate.

12. A substrate processing apparatus comprising:
substrate holding means for holding a substrate in a horizontal posture;
substrate rotating means for rotating the substrate held by said substrate holding means about a vertical axis;
a discharge nozzle for discharging a cleaning solution from an outlet to a surface of the substrate held by said substrate holding means and rotated by said substrate rotating means;
cleaning solution feed means for feeding the cleaning solution to said discharge nozzle; and
nozzle moving means for moving said outlet of the discharge nozzle for scanning from a position opposed to a center of the substrate to a position opposed to a circumferential edge of the substrate while the cleaning solution is being discharged onto the surface of the substrate from said outlet;
wherein there is further provided control means for controlling said cleaning solution feed means so that a discharge pressure of the cleaning solution to be discharged onto the surface of the substrate from said outlet of the discharge nozzle is decreased in a process that said outlet of the discharge nozzle is traveled from the position opposed to the center of the substrate to the position opposed to the circumferential edge of the substrate.
